(19) United States
(12) Patent Application Publication
(10) Pub. No.: US 2021/0129116 A1
(43) Pub. Date: May 6, 2021

(54) METHOD FOR PRODUCING COATING LAYER FOR EXHAUST GAS PURIFICATION CATALYST DEVICE

(71) Applicant: TOYOTA JIDOSHA KABUSHIKI KAISHA, Toyota-shi (JP)

(72) Inventors: Jota Yamauchi, Susono-shi (JP); Toshihisa Yamauchi, Yaizu-shi (JP); Yohei Kinoshita, Shizuoka-shi (JP); Takahiro Hayashi, Susono-shi (JP)

(73) Assignee: TOYOTA JIDOSHA KABUSHIKI KAISHA, Toyota-shi (JP)

(21) Appl. No.: 17/060,830

(22) Filed: Oct. 1, 2020

(30) Foreign Application Priority Data
Nov. 1, 2019 (JP) 2019-200121

(51) Int. Cl. B01J 23/44; B01J 23/10; B01J 35/02; B01J 37/02

(52) U.S. Cl. CPC B01J 23/44; B01J 23/10; B01D 53/94; B01J 37/0219; B01J 37/0236; B01J 35/026

(57) ABSTRACT

A method is provided for producing a coating layer for an exhaust gas purification catalyst device that can inhibit detachment of the coating layer when the coating layer is formed on the exhaust gas purification catalyst device. The method comprises covering a substrate with a slurry that comprises carrier particles and a dispersing medium, to form a slurry layer on the substrate, and drying and firing the slurry layer to form a coating layer, wherein the carrier particles have a median diameter (D50) of 4.00 μm or smaller, the dispersing medium comprises water and a water-soluble alcohol, and the amount of the water-soluble alcohol in the slurry is 0.50 mass % to 12.00 mass % with respect to the slurry.

### FIELD

The present disclosure relates to a method for producing a coating layer for an exhaust gas purification catalyst device.

### BACKGROUND

One known step in a method for producing a coating layer for an exhaust gas purification catalyst device is to coat a substrate with a slurry containing carrier particles, and to dry and fire the coating.

More specifically, as a method of producing a coating layer for an exhaust gas purification catalyst device, PTL 1 discloses supporting Pt and Pd as catalyst metals on an Al₂O₃—ZrO₂—TiO₂ complex oxide used as support powder, and dispersing this in water as a dispersing medium to prepare a slurry, coating the slurry onto a cordierite honeycomb base material as a substrate, and then drying and firing it.

### CITATION LIST

### Patent Literature

[PTL 1] Japanese Unexamined Patent Publication No. 2018-69156

### SUMMARY

### Technical Problem

Exhaust gas purification catalysts are known which have a construction comprising a coating layer that comprises carrier particles supporting a catalyst metal, formed on the surface of a substrate. Such exhaust gas purification catalysts are used by being situated in the gas passage of an exhaust pipe to purify noxious components in exhaust gas.

One goal for such uses is to narrow the coating layer in order to widen the gas passage and lower pressure loss of the exhaust gas, so that engine output is increased.

In methods for producing coating layers for exhaust gas purification catalyst devices, as described in PTL 1, a step is carried out in which a slurry containing carrier particles is coated onto a substrate to form a slurry layer, and is dried and fired to obtain a coating layer.

The present inventors have found that when the coating layer is formed by drying the slurry layer in this step, cracks are often generated in the surface of the coating layer, and that such cracks are more likely to form with smaller particle sizes of the carrier particles used during production.

The present inventors have also found that cracks formed in the surface of the coating layer widen further with sudden increase in temperature difference during use, tending to result in detachment of the coating layer from its coated sections and making it impossible to obtain sufficient durability.

It is an object of the present disclosure to provide a method for producing a coating layer for an exhaust gas purification catalyst device that can inhibit detachment of the coating layer when the coating layer is formed on the exhaust gas purification catalyst device.

### Solution to Problem

The present inventors have found that this object can be achieved by the following means.

### <Aspect 1>

A method for producing a coating layer for an exhaust gas purification catalyst device, the method comprising:

covering a substrate with a slurry containing carrier particles and a dispersing medium to form a slurry layer on the substrate, and

drying and firing the slurry layer to form a coating layer, wherein

the carrier particles have a median diameter (D50) of 4.00 μm or smaller,

the dispersing medium comprises water and a water-soluble alcohol, and

the amount of the water-soluble alcohol in the slurry is 0.50 mass % to 12.00 mass % with respect to the slurry.

### <Aspect 2>

The method according to aspect 1, wherein the median diameter (D50) of the carrier particles is 3.00 μm or smaller.

### <Aspect 3>

The method according to aspect 1 or 2, wherein the surface tension of the water-soluble alcohol is lower than the surface tension of water.

### <Aspect 4>

The method according to any one of aspects 1 to 3, wherein the water-soluble alcohol is methanol, ethanol, 1-propanol, 2-propanol, ethylene glycol or glycerin, or a combination thereof.

### <Aspect 5>

The method according to any one of aspects 1 to 4, wherein the amount of the water-soluble alcohol in the slurry is 0.50 mass % to 2.00 mass % with respect to the slurry.

### <Aspect 6>

The method according to any one of aspects 1 to 5, wherein the viscosity of the slurry is 2000 mPa·s to 4000 mPa·s.

### <Aspect 7>

The method according to any one of aspects 1 to 6, wherein the catalyst metal is supported on the carrier particles.

### <Aspect 8>

The method according to aspect 7, wherein the catalyst metal is Rh, Pt or Pd, or a combination thereof.

### <Aspect 9>

The method according to any one of aspects 1 to 8, wherein the carrier particles are silica (SiO₂), zirconia (ZrO₂), ceria (CeO₂), alumina (Al₂O₃) or titania (TiO₂), or a solid solution thereof, or a combination thereof.

### <Aspect 10>

The method according to any one of aspects 1 to 9, wherein the substrate is made of a ceramic or metal.

### Advantageous Effects of Invention

According to the present disclosure, it is possible to provide a method for producing a coating layer for an exhaust gas purification catalyst device, the method being able to inhibit detachment of the coating layer when the coating layer for the exhaust gas purification catalyst is formed.

### BRIEF DESCRIPTION OF DRAWINGS

FIG. 1 is a schematic diagram showing a slurry layer 2 formed on a substrate 1 in a production method according to an embodiment of the disclosure.

FIG. 2 is a schematic diagram showing a coating layer 3 produced by a production method according to an embodiment of the disclosure.

FIG. 3 is a schematic diagram showing a slurry layer 2′ formed on a substrate 1 in a production method that is different from the embodiment of the disclosure.

FIG. 4 is a schematic diagram showing a coating layer 3′ produced by a production method that is different from the embodiment of the disclosure.

FIG. 5 is a schematic diagram showing a slurry layer 2″ formed on a substrate in another production method that is different from the embodiment of the disclosure.

FIG. 6 is a graph showing detachment rates for the coating layers of the exhaust gas purification catalysts of Examples 1 and 2 and Comparative Example 3, after durability testing at 900° C. and 1000° C.

FIG. 7 is a graph showing detachment rates for the coating layers of the exhaust gas purification catalysts of an Example, a Comparative Example and a Reference Example, after durability testing at 900° C.

FIG. 8 is a graph showing detachment rates for the coating layers of the exhaust gas purification catalysts of an Example, a Comparative Example and a Reference Example, after durability testing at 1000° C.

### DESCRIPTION OF EMBODIMENTS

Embodiments of the disclosure will now be explained in detail. However, the disclosure is not limited to the embodiments described below, and various modifications may be implemented within the scope of the gist thereof.

The production method of the disclosure for producing a coating layer for an exhaust gas purification catalyst device comprises covering a substrate with a slurry that comprises carrier particles and a dispersing medium, to form a slurry layer on the substrate, and drying and firing the slurry layer to form a coating layer, wherein the carrier particles have a median diameter (D50) of 4.00 μm or smaller, the dispersing medium comprises water and a water-soluble alcohol, and the amount of water-soluble alcohol in the slurry is 0.50 mass % to 12.00 mass % with respect to the slurry.

Without being limited to any particular principle, the following may be assumed to be the principle of the method of the disclosure whereby detachment of the coating layer is inhibited when the coating layer for the exhaust gas purification catalyst device is formed.

As mentioned above, the present inventors have found that when the coating layer is formed by drying the slurry layer, cracks are often generated in the surface of the coating layer, and that such cracks are more likely to form with smaller particle sizes of the carrier particles used during production.

In this regard, without being restricted to any particular principle, it is believed that when water is used as the dispersing medium for a slurry used to form a coating layer, and the slurry layer is dried to form the coating layer, a meniscus of water with high surface tension forms on the coating layer surface, causing the easily movable particles of small particle size to become attracted to each other, and as a result, stress is produced on the slurry layer surface. When stress is thus produced on the slurry layer surface when the slurry layer is dried to form the coating layer, presumably cracking origins are formed at those sections, causing cracks to be generated from the origins.

In an environment where it is actually used, the exhaust gas purification catalyst is exposed to exhaust gas that comprises water vapor, and to abrupt temperature differences before and after engine start-up, and therefore when the coating layer has cracks, those cracks can propagate, tending to cause detachment of the coating layer.

The present inventors, knowing that a solution comprising a mixture of water and alcohol has a lower surface tension than water, have investigated solving this problem by using a solution comprising water and an alcohol as the dispersing medium.

When the dispersing medium comprises water and an alcohol, the surface tension of the slurry is lower compared to water alone as the dispersing medium, and therefore it is possible to inhibit generation of cracks on the coating layer surface when the slurry layer is dried to form the coating layer.

Further investigation by the present inventors has shown that if the alcohol concentration in the dispersing medium is too high, it becomes difficult to inhibit generation of cracks in the coating layer surface.

Without being limited to any particular principle, when the alcohol concentration in the dispersing medium is too high, the alcohol becomes unevenly dispersed in the dispersing medium, thus leading to non-uniform dispersion of the carrier particles in the dispersing medium and consequently a greater tendency for cracks to form in the coating layer surface during drying.

The present disclosure provides a method of forming a coating layer that has reduced generation of cracks in the coating layer surface and therefore resistance to detachment, by limiting the concentration of the alcohol in the dispersing medium to within a predetermined range when the particle sizes of the carrier particles have been reduced.

The principle of the production method of the disclosure will now be described in greater detail, based on diagrams illustrating the production method according to an embodiment of the disclosure and a production method different from the embodiment of the disclosure.

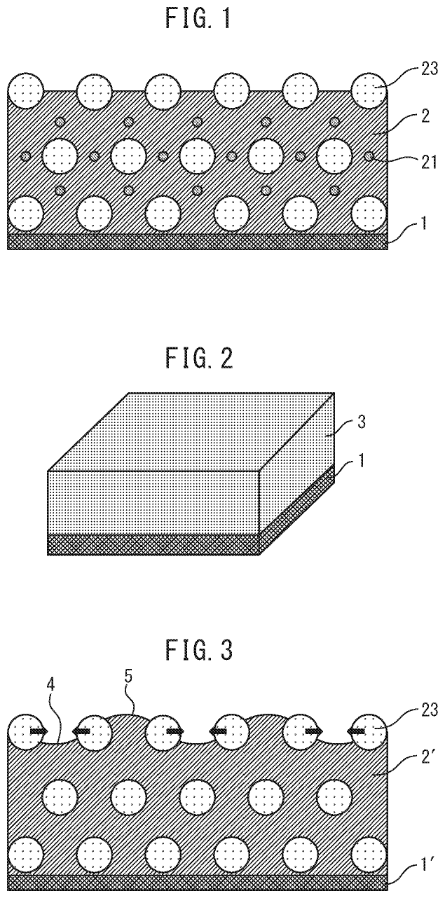

FIG. 1 is a schematic diagram showing a slurry layer 2 formed on a substrate 1 in a production method according to an embodiment of the disclosure. FIG. 2 is a schematic diagram showing a coating layer 3 produced by a production method according to an embodiment of the disclosure.

When a substrate 1 is covered with a slurry formed using a liquid mixture of water and alcohol 21 as the dispersing medium, as shown in FIG. 1, the surface tension of the dispersing medium is low, so that meniscus formation is less likely to occur at the surface section of the slurry layer 2 that is formed. The alcohol 21 and carrier particles 23 are homogeneously dispersed in the slurry layer 2. Stress at the surface section of the slurry layer 2 is therefore reduced, and cracks are unlikely to be generated. A coating layer 3 with few or no cracks can therefore be formed, as shown in FIG. 2.

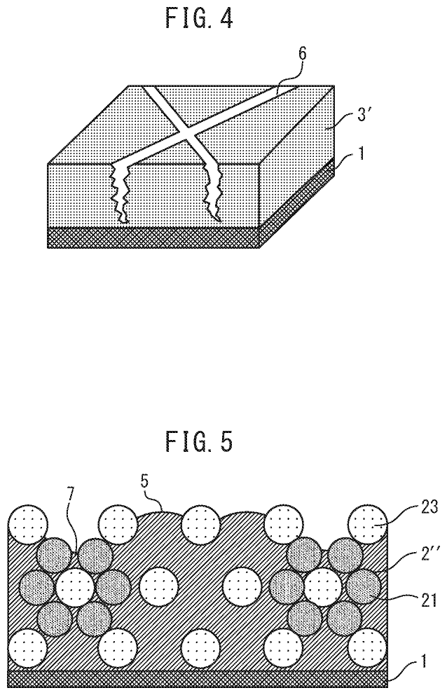

On the other hand, in a different production method from the embodiment of the disclosure, using only water as the dispersing medium as described below with reference to FIGS. 3 and 4, it is not possible to adequately inhibit generation of cracks in the surface of the coating layer 3.

FIG. 3 is a schematic diagram showing a slurry layer 2′ formed on a substrate 1 in a production method that is different from the embodiment of the disclosure, and FIG. 4 is a schematic diagram showing a coating layer 3′ produced by a production method that is different from the embodiment of the disclosure.

When a substrate is covered with a slurry formed using water as the dispersing medium, as shown in FIG. 3, a meniscus 4 forms by the high-surface-tension water at the surface section of the slurry layer 2′ that is formed. The meniscus 4 causes the carrier particles 23 to be mutually attracted. Stress is therefore produced at the surface section of the slurry layer 2, and a crack origin 5 is formed. When drying later progresses, the crack origin 5 results in formation of a crack. A crack 6 forms in the surface of the coating layer 3, as shown in FIG. 4.

In another production method that is different from the embodiment of the disclosure, with a high concentration of alcohol 21 in the dispersing medium as described below with reference to FIG. 5, it is still not possible to adequately inhibit generation of cracks 6 in the surface of the coating layer 3.

FIG. 5 is a schematic diagram showing a slurry layer 2″ formed on a substrate 1 in another production method that is different from the embodiment of the disclosure.

Even when a mixture of water and alcohol 21 is used as the dispersing medium, if the alcohol 21 concentration in the dispersing medium is high, as shown in FIG. 5, the alcohol 21 becomes unevenly dispersed 7 in the dispersing medium, thus resulting in non-uniform dispersion of the carrier particles 23 in the dispersing medium. During drying, therefore, a crack origin 5 forms at a section of low dispersion of the carrier particles 23. When drying later progresses, the crack origin 5 results in formation of a crack 6. A crack 6 forms in the surface of the coating layer 3′, similar to the state shown in FIG. 4.

### <Formation of Slurry Layer>

In the method of the disclosure, the slurry layer is formed by covering a substrate with a slurry containing carrier particles and dispersing medium. The method of covering the substrate with the slurry is not particularly restricted, and it may be any publicly known method. Examples of methods of covering substrates with slurries include, but are not limited to, dip coating methods, spin coating methods, spraying methods, impregnation methods and wash coat methods.

### <Formation of Coating Layer>

In the method of the disclosure, the coating layer is formed by drying and firing a slurry layer formed on a substrate.

The temperature, time and atmosphere for drying are not particularly restricted. For example, it may be a temperature in the range of 80° C. to 120° C., for a time in the range of 1 to 10 hours, and in an air atmosphere.

The drying temperature may be 80° C. or higher, 90° C. or higher or 100° C. or higher, and 120° C. or lower, 110° C. or lower or 100° C. or lower.

The drying time may be 3 minutes or longer, 5 minutes or longer, 10 minutes or longer or 30 minutes or longer, and 5 hours or less, 3 hours or less, 1 hour or less or 30 minutes or less.

The temperature, time and atmosphere for firing are also not particularly restricted. For example, it may be a temperature in the range of 400° C. to 1000° C., for a time in the range of 2 to 4 hours, and in an air atmosphere.

The firing temperature may be 400° C. or higher, 500° C. or higher or 600° C. or higher, and 1000° C. or lower, 900° C. or lower or 700° C. or lower.

The firing time may be 1 hour or longer, 2 hours or longer, 2 hours and 30 minutes or longer or 3 hours or longer, and 4 hours or less, 3 hours and 30 minutes or less or 3 hours or less.

The firing may be carried out in an electric furnace, for example.

### <Slurry>

The slurry comprises carrier particles and a dispersing medium. From the standpoint of production of the coating layer to be formed, the slurry may also comprise other materials, depending on the desired purpose of use, performance and properties.

### <Carrier Particles>

The carrier particles have a median diameter (D50) of 4.00 μm or smaller.

If the carrier particles have a median diameter (D50) of this size it will be possible to reduce the thickness of the coating layer that is formed.

The median diameter (D50) of the carrier particles may be 4.00 μm or smaller, 3.00 μm or smaller or 2.00 μm or smaller, and 1.00 μm or greater, 2.00 μm or greater or 3.00 μm or greater.

The median diameter (D50) of the carrier particles can be measured by particle size distribution measurement using a laser diffraction particle size distribution meter (SALD-2300) by Shimadzu Corp., determining the particle size at 50% cumulative frequency.

The carrier particles may be any desired carrier particles that can support a catalyst metal to form an exhaust gas purification catalyst. More specifically, the carrier particles may be silica (SiO₂), zirconia (ZrO₂), ceria (CeO₂), alumina (Al₂O₃) or titania (TiO₂), a solid solution thereof, or a combination thereof.

The carrier particles to be used for the production method of the disclosure may have the catalyst metal supported or not supported on them. When the catalyst metal is not supported on the carrier particles, the catalyst metal may be supported on the carrier particles in a step during the production method of the disclosure, or after formation of the coating layer by the production method of the disclosure.

### <Dispersing Medium>

The dispersing medium contains water and a water-soluble alcohol. The dispersing medium contains the water-soluble alcohol in an amount so that the water-soluble alcohol is present in the slurry at 0.50 mass % to 12.00 mass % with respect to the slurry.

### (Water-Soluble Alcohol)

According to the disclosure, a water-soluble alcohol is an alcohol that is miscible with water in any desired proportion at room temperature (25° C.). The surface tension of the water-soluble alcohol may be lower than that of water.

The water-soluble alcohol is not particularly restricted, but from the viewpoint of easy manageability it may be methanol, ethanol, 1-propanol, 2-propanol, ethylene glycol or glycerin, or a combination thereof.

The dispersing medium contains the water-soluble alcohol in an amount so that the water-soluble alcohol is present in the slurry at 0.50 mass % to 12.00 mass % with respect to the slurry.

If the amount of water-soluble alcohol in the dispersing medium is too low, i.e. if the amount of water-soluble alcohol in the slurry is less than 0.50 mass % with respect to the slurry, then it will not be possible to adequately lower the surface tension of the dispersing medium, or to adequately inhibit generation of cracks.

If the amount of water-soluble alcohol in the dispersing medium is too high, i.e. if the amount of water-soluble alcohol in the slurry is greater than 12.00 mass % with respect to the slurry, then dispersion of the water-soluble alcohol in the dispersing medium will be uneven, and it will not be possible to adequately inhibit generation of cracks.

The amount of water-soluble alcohol in the slurry may be 0.50 mass % or greater, 1.00 mass % or greater, 2.00 mass % or greater or 5.00 mass % or greater, and 12.00 mass % or lower, 10.00 mass % or lower, 5.00 mass % or lower or 2.00 mass % or lower, with respect to the slurry.

The amount of water-soluble alcohol in the slurry is most preferably 0.50 mass % to 2.00 mass % with respect to the slurry. If the amount of water-soluble alcohol in the slurry is within this range, it will be possible to adequately inhibit generation of cracks even when the median diameter (D50) of the carrier particles is smaller.

### <Other Materials>

From the standpoint of production of the coating layer to be formed, the slurry may also comprise other materials, depending on the desired purpose of use, performance and properties. Examples of such materials include, but are not limited to, catalyst metals, NOx occlusion materials, co-catalysts, binders and thickeners.

### (Catalyst Metal)

A catalyst metal is not particularly restricted so long as it has properties as an exhaust gas purification catalyst.

Examples of catalyst metals that may be selected include platinum group elements such as Rh, Pt and/or Pd.

A catalyst metal can be supported on the carrier particles. The method of supporting the catalyst metal on the carrier particles may be a publicly known method. The catalyst metal can be supported on the carrier particles by, for example, impregnating the carrier particles with a solution containing the catalyst metal at a predetermined concentration, and drying them.

When the slurry does not contain a catalyst metal, the catalyst metal may be supported on the carrier particles in the coating layer after the coating layer has been produced by the production method of the disclosure. The specific method may be impregnation of the coating layer with a solution containing the catalyst metal at a predetermined concentration, and drying.

### (NOₓ Occlusion Material)

A NOₓ occlusion material is not particularly restricted so long as it is able to occlude NOₓ. Examples of NOₓ occlusion materials include alkali metals and their salts, such as lithium, potassium, alkaline earth metals such as barium, and combinations thereof.

### (Co-Catalyst)

A co-catalyst is not particularly restricted so long as it does not inhibit the catalytic activity of the catalyst metal for NOₓ reduction. The co-catalyst may be used to further increase catalytic activity, such as the catalytic activity of the catalyst metal. Co-catalysts are not particularly restricted, and an example is ceria.

### (Binder)

Binders are not particularly restricted, and alumina sol is an example.

### (Thickener)

A thickener may be any material that is able to provide the desired viscosity to the slurry layer, and it may be a thickener containing water-soluble cellulose, for example.

The slurry layer viscosity is preferably 2000 mPa·s to 4000 mPa·s.

The slurry layer viscosity may be 2000 mPa·s or higher, 2500 mPa·s or higher or 3000 mPa·s or higher, and 4000 mPa·s or lower, 3500 mPa·s or lower or 3000 mPa·s or lower.

The method of measuring the viscosity of the slurry may be a method using a TVB-35L by Toki Sangyo Co., Ltd. at a driving shaft rotational speed of 30 rpm, determining the viscosity after 3 minutes from the start of measurement as the viscosity of the slurry.

### <Substrate>

The material of the substrate is not particularly restricted, and for example, a ceramic or metal substrate may be used. Examples of ceramic substrates include cordierite and SiC substrates.

The substrate may also have flow channels for passage of exhaust gas when the purpose is to produce an exhaust gas purification catalyst device. The structure of the flow channels may be a honeycomb structure, foam structure or plate structure, for example.

### EXAMPLES

### Examples 1 and 2, Comparative Example 1, Reference Examples 1-1 to 1-3, Reference Examples 2-1 to 2-3 and Reference Examples 3-1 and 3-2

### Example 1

After adding 12 g of a Pd nitrate solution (8.6 mass %) to 100 g of an Al₂O₃—CeO₂—ZrO₂ complex oxide powder as carrier particles, the mixture was evaporated to dryness and fired in an electric furnace at 500° C. for 2 hours, to obtain carrier particles having Pd supported as a catalyst metal, i.e. Pd-supporting carrier particles. The Pd was used at 1 wt % with respect to the Pd-supporting carrier particles.

Next, 75 g of the Pd-supporting carrier particles was mixed with 5 g of a boehmite binder and 75 g of alumina, and water and ethanol were added as dispersing medium to prepare a slurry.

The obtained slurry was placed in a 1 L pot and filled with φ11 mm silicon nitride balls to ⅓ of the height of the container, and then rotated for 24 hours on a roller stand for milling.

The median diameter (D50) of the Pd-supporting carrier particles in the slurry after milling was measured to be 2.00 μm, by particle size distribution measurement using a laser diffraction particle size distribution meter (SALD-2300) by Shimadzu Corp., determining the particle size at 50% cumulative frequency.

To increase the viscosity of the slurry, 2 g of water-soluble cellulose was added to a mixed solution of 49 g of water and 49 g of ethanol, to prepare a thickener. When coating, the thickener was added to the slurry to a slurry viscosity of 2000 mPas to 4000 mPas.

The slurry viscosity was measured using a TVB-35L by Toki Sangyo Co., Ltd. at a driving shaft rotational speed of 30 rpm, determining the viscosity after 3 minutes from the start of measurement as the viscosity of the slurry.

The ethanol content of the slurry at that point was about 1%. Water was added to adjust the solid content to 3.5 g (solid content) per coating. The ethanol concentration of the slurry actually used for coating was 0.84 mass %.

Using a wash coat method, a cordierite honeycomb substrate (q 30 mm, L=105 mm) was coated with the slurry, once each from the front and rear, and was then ventilation dried at 90° C. for 5 minutes and fired at 500° C. for 2 hours in an electric furnace, to obtain an exhaust gas purification catalyst for Example 1.

### Example 2

An exhaust gas purification catalyst for Example 2 was obtained in the same manner as Example 1, except that the amount of water and ethanol in the dispersing medium was adjusted so that the ethanol concentration in the slurry actually used for coating was 9.57 mass %.

### Reference Examples 1-1 to 1-3

Exhaust gas purification catalysts for Reference Examples 1-1 to 1-3 were obtained in the same manner as Comparative Example 1, except that the amount of dispersing medium used was adjusted to change the solid content in the slurry before milling, thereby changing the median diameter (D50) of the Pd-supporting carrier particles in the slurry after milling.

The median diameter (D50) of the Pd-supporting carrier particles used for production of the exhaust gas purification catalysts of Reference Examples 1-1 to 1-3, and the concentration (mass %) of ethanol in the slurry actually used for coating, are shown in Table 1 below.

### Reference Examples 2-1 to 2-3

Exhaust gas purification catalysts for Reference Examples 2-1 to 2-3 were obtained in the same manner as Example 1, except that the amount of dispersing medium used was adjusted to change the solid content in the slurry before milling, thereby changing the median diameter (D50) of the Pd-supporting carrier particles in the slurry after milling.

The median diameter (D50) of the Pd-supporting carrier particles used for production of the exhaust gas purification catalysts of Reference Examples 2-1 to 2-3, and the concentration (mass %) of ethanol in the slurry actually used for coating, are shown in Table 1 below.

### Reference Examples 3-1 and 3-2

Exhaust gas purification catalysts for Reference Examples 3-1 and 3-2 were obtained in the same manner as Example 2, except that the amount of dispersing medium used was adjusted to change the solid content in the slurry before milling, thereby changing the median diameter (D50) of the Pd-supporting carrier particles in the slurry after milling.

The median diameter (D50) of the Pd-supporting carrier particles used for production of the exhaust gas purification catalysts of Reference Examples 3-1 and 3-2, and the concentration (mass %) of ethanol in the slurry actually used for coating, are shown in Table 1 below.

### <Durability Test>

A 10 mm-square piece was cut out from near the center of each of the exhaust gas purification catalysts of the Examples, to prepare a sample for each Example.

Each sample was subjected to two different durability tests in an electric furnace, at 900° C. for 5 hours and at 1100° C. for 5 hours. The weight of each sample was then measured as the weight before testing.

Each sample was then placed in a 50 ml beaker, 50 ml of water was added to the beaker, and ultrasonic wave vibration was applied for 5 minutes. Each sample was then dried in an electric furnace at 250° C. for 30 minutes, and the weight was measured as the weight after testing.

The value of the weight after testing subtracted from the weight before testing was divided by the weight before testing to determine the detachment rate.

### <Results>

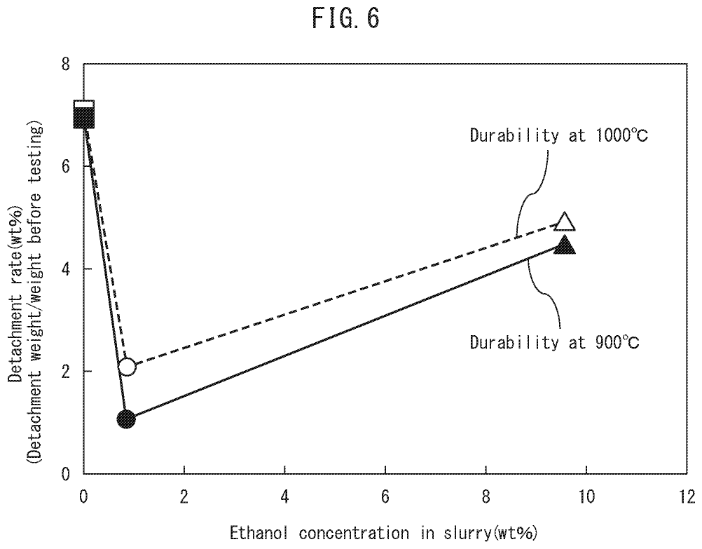

The conditions and durability test results for each of the samples are summarized in Table 1 and FIGS. 6 to 8.

The black square and white square points in FIG. 6 indicate the detachment rates in the durability test at 900° C. and 1000° C., respectively, for the exhaust gas purification catalyst of Comparative Example 1. Similarly, the black circle and white circle points indicate the detachment rates in the durability test at 900° C. and 1000° C., respectively, for the exhaust gas purification catalyst of Example 1, and the black triangle and white triangle points indicate the same for Example 2.

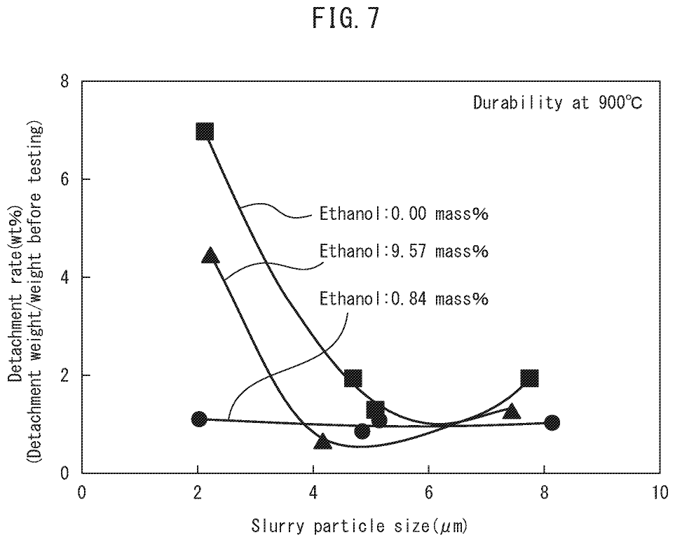

In FIG. 7, the black square plots indicate the plots for detachment rate in the durability test at 900° C. for the exhaust gas purification catalysts of Comparative Example 1 and Reference Examples 1-1 to 1-3. Similarly, the black circle plots indicate the plots for detachment rate in the durability test at 900° C. for the exhaust gas purification catalysts of Example 1 and Reference Examples 2-1 to 2-3, and the black triangle plots indicate the same for Example 2 and Reference Examples 3-1 and 3-2.

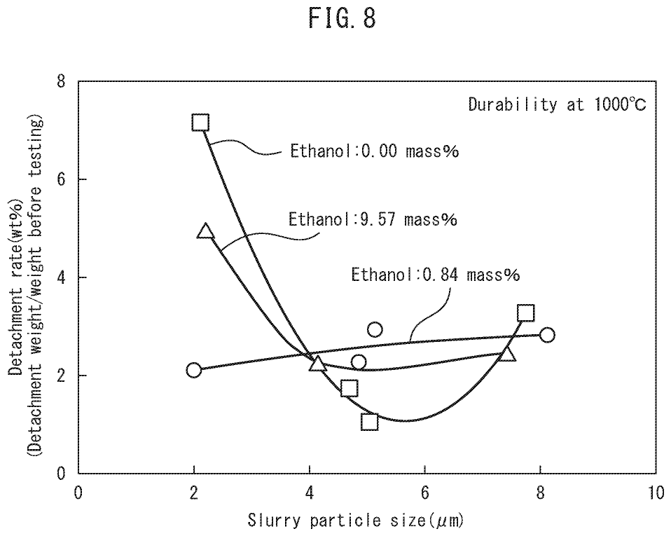

In FIG. 8, the white square plots indicate the plots for detachment rate in the durability test at 1000° C. for the exhaust gas purification catalysts of Comparative Example 1 and Reference Examples 1-1 to 1-3. Similarly, the white circle plots indicate the plots for detachment rate in the durability test at 1000° C. for the exhaust gas purification catalysts of Example 1 and Reference Examples 2-1 to 2-3, and the white triangle plots indicate the same for Example 2 and Reference Examples 3-1 and 3-2.

TABLE 1

| | Conditions | | Results | |
|---|---|---|---|---|
| | Median | | Detachment rate | Detachment rate |
| | diameter | Ethanol | in 900° C. | in 1000° C. |
| | of carrier | concentration | durability | durability |
| | particles | in slurry | test | test |
| Example | (μm) | (mass %) | (mass %) | (mass %) |
| Comparative Example 1 | 2.10 | 0.00 | 6.80 | 7.00 |
| Reference Example 1-1 | 4.70 | 0.00 | 2.00 | 1.80 |
| Reference Example 1-2 | 5.10 | 0.00 | 1.30 | 1.00 |
| Reference Example 1-3 | 7.80 | 0.00 | 2.00 | 3.20 |
| Example 1 | 2.00 | 0.84 | 1.20 | 2.00 |
| Reference Example 2-1 | 4.80 | 0.84 | 1.00 | 2.00 |
| Reference Example 2-2 | 5.20 | 0.84 | 1.20 | 3.00 |
| Reference Example 2-3 | 8.20 | 0.84 | 1.20 | 3.00 |
| Example 2 | 2.20 | 9.57 | 4.50 | 5.00 |
| Reference Example 3-1 | 4.20 | 9.57 | 0.67 | 2.10 |
| Reference Example 3-2 | 7.40 | 9.57 | 1.30 | 2.30 |

As shown in Table 1 and FIG. 6, the detachment rates of the coating layers in the durability test at 900° C. and 1000° C. were 6.80% and 7.00%, respectively, in Comparative Example 1 which had an ethanol concentration of 0.00 mass % in the slurry, i.e. which used water alone as the dispersing medium.

In contrast, in Example 1 which had an ethanol concentration of 0.84 mass % in the slurry, the detachment rates of the coating layers in the durability test at 900° C. and 1000° C. were 1.20% and 2.00%, respectively, which were lower than the detachment rates of Comparative Example 1.

In Example 2 as well, which had an ethanol concentration of 9.57 mass % in the slurry, the detachment rates of the coating layers in the durability test at 900° C. and 1000° C. were 4.50% and 5.00%, respectively, which were lower than the detachment rates of Comparative Example 1.

When the results of durability testing for Examples 1 and 2 are compared, the detachment rates of the coating layers were particularly low in Example 1, which had a lower ethanol concentration in the slurry.

As shown in Table 1 and FIGS. 7 and 8, when Comparative Example 1 which used water alone as the dispersing medium is compared with Reference Examples 1-1 to 1-3, it is seen that a small median diameter (D50) of the carrier particles in the slurry, i.e. 4.0 μm or lower, tended to result in high detachment rates of the coating layer in durability testing at 900° C. and 1000° C.

In contrast, when Example 1 which had an ethanol concentration of 0.84 mass % in the slurry is compared with Reference Examples 2-1 to 2-3, the detachment rates of the coating layer in durability testing at 900° C. and 1000° C. were low and approximately the same, regardless of the size of the median diameter (D50) of the carrier particles in the slurry.

When Example 2 which had an ethanol concentration of 9.57 mass % in the slurry is compared with Reference Examples 3-1 and 3-2, a small median diameter (D50) of the carrier particles in the slurry, i.e. 4.0 μm or lower, tended to result in higher detachment rates of the coating layer in durability testing at 900° C. and 1000° C. The detachment rate of the exhaust gas purification catalyst in Example 2 was naturally lower than that of the exhaust gas purification catalyst of Comparative Example 1.

Based on these results, it can be concluded that a small median diameter (D50) of the carrier particles in the slurry, i.e. 4.0 μm or lower, tends to increase the detachment rate of the coating layer that is produced, but that by using a liquid mixture of water and alcohol as the dispersing medium, and limiting the alcohol concentration to within a predetermined range, it is possible to lower the detachment rate of the produced coating layer even with a small median diameter (D50) of the carrier particles in the slurry.

### REFERENCE SIGNS LIST

1 Substrate
2, 2′ and 2″ Slurry layer
3, 3′ Coating layer
4 Meniscus
5 Crack origin
6 Crack
7 Uneven dispersion
21 Alcohol
23 Carrier particles

1. A method for producing a coating layer for an exhaust gas purification catalyst device, the method comprising:
covering a substrate with a slurry containing carrier particles and a dispersing medium to form a slurry layer on the substrate, and
drying and firing the slurry layer to form a coating layer, wherein
the carrier particles have a median diameter (D50) of 4.00 μm or smaller,
the dispersing medium comprises water and a water-soluble alcohol, and
the amount of the water-soluble alcohol in the slurry is 0.50 mass % to 12.00 mass % with respect to the slurry.

2. The method according to claim 1, wherein the median diameter (D50) of the carrier particles is 3.00 μm or smaller.

3. The method according to claim 1, wherein the surface tension of the water-soluble alcohol is lower than the surface tension of water.

4. The method according to claim 1, wherein the water-soluble alcohol is methanol, ethanol, 1-propanol, 2-propanol, ethylene glycol or glycerin, or a combination thereof.

5. The method according to claim 1, wherein the amount of the water-soluble alcohol in the slurry is 0.50 mass % to 2.00 mass % with respect to the slurry.

6. The method according to claim 1, wherein the viscosity of the slurry is 2000 mPa·s to 4000 mPa·s.

7. The method according to claim 1, wherein the catalyst metal is supported on the carrier particles.

8. The method according to claim 7, wherein the catalyst metal is Rh, Pt or Pd, or a combination thereof.

9. The method according to claim 1, wherein the carrier particles are silica (SiO₂), zirconia (ZrO₂), ceria (CeO₂), alumina (Al₂O₃) or titania (TiO₂), or a solid solution thereof, or a combination thereof.

10. The method according to claim 1, wherein the substrate is made of a ceramic or metal.
